(19) United States
(12) Patent Application Publication
(10) Pub. No.: US 2008/0217911 A1
(43) Pub. Date: Sep. 11, 2008

(54) ONE-PIECE ELBOW HYDRAULIC FITTING DESIGNED FOR ELECTRIC ARC STUD WELDING

(75) Inventors: Cornel Irimies, Grafton, OH (US); Daniel L. Hannan, Westlake, OH (US)

Correspondence Address: GIFFORD, KRASS, SPRINKLE,ANDERSON & CITKOWSKI, P.C, PO BOX 7021, TROY, MI, 48007-7021, US

(73) Assignee: Nelson Stud Welding, Inc., Elyria, OH (US)

(21) Appl. No.: 12/044,235

(22) Filed: Mar. 7, 2008

Related U.S. Application Data
(60) Provisional application No. 60/893,460, filed on Mar. 7, 2007.

(51) Int. Cl. F16L 43/00

(52) U.S. Cl. 285/179

(57) ABSTRACT

A hydraulic port weld stud that includes a stud portion having a longitudinal axis and a first bore formed along the longitudinal axis less than an entire length of the stud portion. A port portion extends along an axis transverse to the longitudinal axis of the stud portion. The port portion includes a second bore extending along the transverse axis and intersects the first bore of the stud portion. The port portion and stud portion are integrally formed without the need for a joining or welding operation.

### CROSS-REFERENCE TO RELATED APPLICATIONS

This application claims priority of U.S. Provisional Patent Application Ser. No. 60/893,460 filed on Mar. 7, 2007 the entire content of which is herein incorporated by reference.

### FIELD OF THE INVENTION

The invention relates to weld studs and with more particularity, to weld studs having a hydraulic port.

### BACKGROUND OF THE INVENTION

Hydraulic port weld studs allow for the attachment of ports onto hydraulic or pneumatic apparatuses. The stud welding process allows for the ports to be attached using a drawn arc stud welding process. The stud welding process applies less heat to the hydraulic port to limit the heat distortion applied to the hydraulic port and a mating part.

Hydraulic port weld studs are known in the art and generally include a first piece that is machined to form a hydraulic fitting that is welded or brazed to a second piece that is used as the weld port stud. Such two-piece hydraulic port weld studs require the brazing or welding together of the two components, resulting in a weak area formed at the interface of the two parts. This area may be prone to failure during use of the hydraulic port. Additionally, the brazing or welding assembly process is time consuming and costly. Therefore, there is a need in the art for an improved hydraulic port weld stud that does not have a weakened area or a potential failure area at the interface of two components and is less prone to leaks when used. Additionally, there is a need in the art for a hydraulic port weld stud that is economical and requires less assembly time while maintaining an improved quality.

### SUMMARY OF THE INVENTION

In a first aspect, there is disclosed a hydraulic port weld stud that includes a stud portion having a longitudinal axis and a first bore formed along the longitudinal axis less than an entire length of the stud portion. A port portion extends along an axis transverse to the longitudinal axis of the stud portion. The port portion includes a second bore extending along the transverse axis and intersects the first bore of the stud portion. The port portion and stud portion are integrally formed without the need for a joining or welding operation.

In a second aspect, there is disclosed a hydraulic port weld stud that includes a stud portion having a longitudinal axis and a first bore formed along the longitudinal axis. A port portion extends along an axis transverse to the longitudinal axis of the stud portion. The port portion includes a second bore extending along the transverse axis and intersects the first bore of the stud portion. The port portion and stud portion are formed from a single piece.

### BRIEF DESCRIPTION OF THE DRAWINGS

FIG. 1 is an isometric view of a single piece hydraulic port weld stud having a male hydraulic fitting;

FIG. 2 is a section taken along a center line of the single piece hydraulic port weld stud of FIG. 1;

FIG. 3 is a side view of the single piece hydraulic port weld stud of FIG. 1 having the bores shown in phantom;

FIG. 4 is an isometric view of a single piece hydraulic port weld stud having a female hydraulic fitting;

FIG. 5 is a section taken along a center line of the single piece hydraulic port weld stud of FIG. 4;

FIG. 6 is a side view of the single piece hydraulic port weld stud of FIG. 4 having the bores shown in phantom;

FIG. 7 is a side view of tie single piece hydraulic port weld stud having a counter bore for an o-ring.

### DETAILED DESCRIPTION OF THE PREFERRED EMBODIMENTS

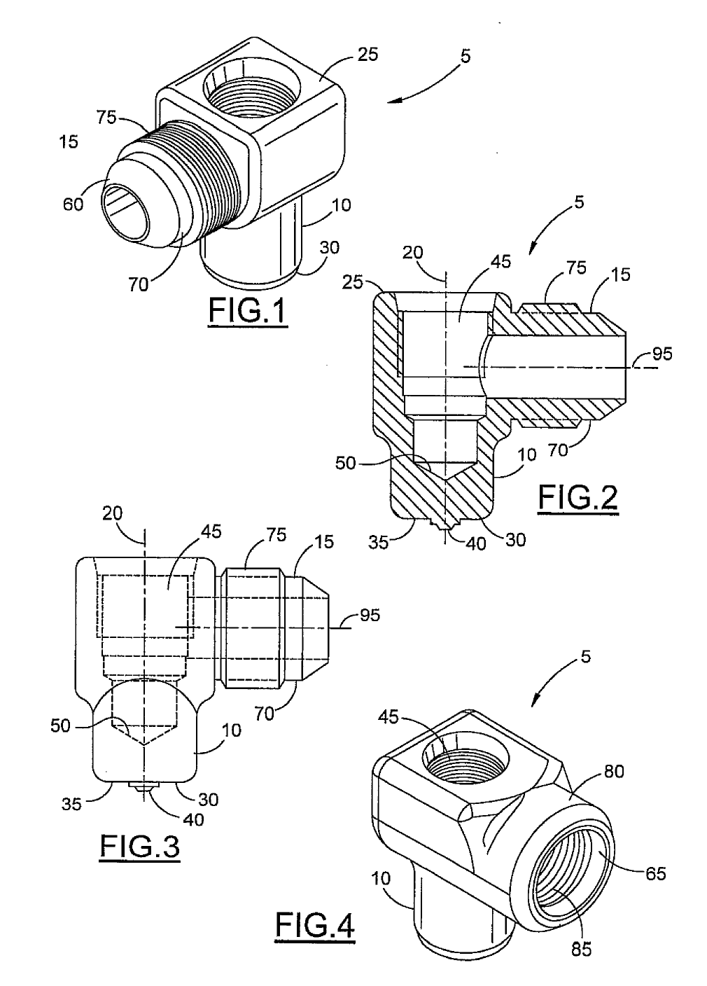

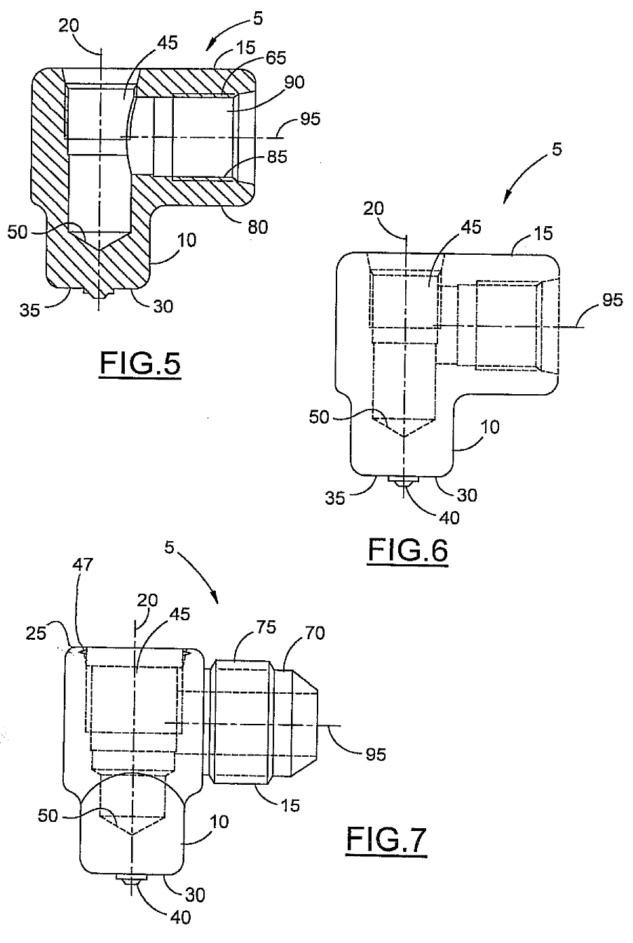

Referring to FIG. 1, there is shown a first embodiment of a hydraulic port weld stud 5. The hydraulic port weld stud 5 includes a stud portion 10 and a port portion 15. In one aspect, the stud portion 10 and port portion 15 are integrally formed and do not require secondary joining operations, such as brazing, welding or other similar operations, to connect the two portions. For example, the stud portion 10 and port portion 15 maybe formed from a single billet or blank of raw material, thereby eliminating the assembly operations necessary to manufacture a hydraulic port weld stud 5. The hydraulic port weld stud 5 may formed in a hot or cold forming operation.

Referring to the figures, the stud portion 10 includes a longitudinal axis 20 that extends from a top surface 25 of the stud portion 10 to a base 30 of the stud portion 10. In one aspect, the base 30 includes a contact surface 35 for attaching to another component. The contact surface 35 may have a flux 40, such as an aluminum material, or other desired material, to aid in the welding of the base 30 to the other component. The stud portion 10 includes a first bore 45 that is formed through the top surface 25 of the stud portion 10 and extends along the longitudinal axis 20 of the stud portion 10. The first bore 45 extends a distance less than the entire length of the stud portion 10. The first bore 45 may include various formations, including counter bores, chamfers, threads, and a pilot portion 50 formed at an end of the first bore 45. The counter bores, threads, and chamfers may be included to allow mating with another component of a hydraulic system. In one aspect and as shown in FIG. 7, the first bore 45 may include a counter bore 47 that receives an o-ring to seal with another component. The pilot portion 50 formed at the end of the first bore 45 may be used to guide a drill bit once the stud portion 10 has been attached to another component, such as a hydraulic cylinder, allowing for boring or drilling through the stud portion 10 into the hydraulic cylinder.

The port portion 15, as stated above, is integrally formed with the stud portion 10. The port portion 15 may include male or female attachment ports 60, 65, as shown in FIGS. 1 and 4. The male attachment port 60 may include threads formed or cut on an outer portion of the male port and may also have flared ends and shaped portions allowing for mating with another coupling or part. As shown in FIG. 1, the male port 60 includes a generally cylindrical body 70 having threads 75 formed or cut on the outer surface and tapering down to a fitting end. However, the female port 65, as shown in FIG. 4, includes a generally cylindrical body 80 having threads 85 formed or cut on an inner surface of the port, allowing for mating with a male coupling.

Both the male and female attachment ports 60, 65 include a second bore 90 formed therein. The second bore 90 is formed through the male or female attachment ports 60, 65 and extends along an axis 95 that is transverse to the longitudinal axis 20 of the stud portion 10. In one aspect, the second bore 90 may be formed at a right angle relative to the longitudinal bore of the stud portion 10, thereby providing a right angle hydraulic port weld stud. It should be realized that the angle of the second bore 90 relative to the first bore 45 may be other than ninety degrees and may vary depending upon the application.

As previously stated, the hydraulic port weld stud 5 is formed of a single billet or piece that may be a forged piece that is machined or otherwise shaped. For example, the first bore 45 may be formed along the longitudinal axis 20 of the stud portion 10, ending in a pilot portion 50 less than an entire length of the stud portion 10. Next, the second bore 90 may be formed through the port portion 15 to intersect at a desired angle with the first bore 45. The various threads and formations of the first bore 45 and second bore 90 may be formed or cut on the inner surface of the first bore 45, as well as the inner and outer surfaces of the second bore 90, depending on the nature of the attachment port being used. For example, the threads and flared area may be formed or cut on the female port 65 on an inner surface of the second bore 90, while the threads may be formed or cut on an outer surface of the cylindrical portion when the attachment port is a male portion 60. A flux 40 may be attached or otherwise connected with the base 30 of the stud portion 10.

In use, the hydraulic port weld stud 5 is positioned in a welding gun and the base 30 of the stud portion 10 is contacted to a surface of a part to be joined. The base 30 of the stud portion 10 is then raised from the surface of the part to be joined and an arc is formed between the two surfaces as tile weld gun is energized. The stud portion 10 is then plunged into a pool of molten metal formed by the arc, such that the stud portion 10 and part to be joined are securely connected together. Following connection of the stud portion 10 to the part to be joined, the first bore 45 may be completed by inserting a drill into the first bore 45, such that the pilot portion 50 guides the drill bit along the longitudinal axis 20 of the stud portion 10, such that the drill bit can complete a bore through the stud portion 10 and through the part to be joined. The hydraulic port weld stud 5 is now coupled to the part to be joined and has a bore or passage between the part to be joined and the weld stud. A cap may be positioned on the top of the first bore 45 utilizing the threads formed or cut on an internal surface of the first bore 45. The cap provides an access port for the hydraulic port weld stud 5. Next, a corresponding part may be joined to the port portion 15, either a male or female part, depending on which type of port portion 15 is utilized.

The invention has been described in an illustrative manner. It is to be understood that the terminology, which has been used, is intended to be in the nature of words of description rather than limitation. Many modifications and variations of the invention are possible in light of the above teachings. Therefore, within the scope of the appended claims, the invention may be practiced other than as specifically described.

1. A one-piece hydraulic port weld stud comprising:
a stud portion having a longitudinal axis and a first bore formed along the longitudinal axis less than an entire length of the stud portion;
a port portion extending along an axis transverse to the longitudinal axis of the stud portion, the port portion including a second bore extending along the transverse axis and intersecting the first bore of the stud portion;
wherein the port portion and stud portion are integrally formed without the need for a joining operation.

2. The hydraulic port weld stud of claim 1 wherein the stud portion includes a top surface separated from a base having a contact surface.

3. The hydraulic port weld stud of claim 2 wherein the contact surface includes a flux material.

4. The hydraulic port weld stud of claim 2 wherein the first bore extends through the top surface and extends along the longitudinal axis towards the base less than a distance to the base and terminates at a pilot portion.

5. The hydraulic port weld stud of claim wherein the first bore includes formations selected from the group consisting of counter bores, threads and chamfers.

6. The hydraulic port weld stud of claim 5 wherein the first bore includes a counter bore receiving an O-ring.

7. The hydraulic port weld stud of claim 1 wherein the port portion includes either a male or female attachment port.

8. The hydraulic port weld stud of claim 7 wherein the male attachment port includes a generally cylindrical body having formations selected from the group consisting of threads, flares and shaped portions.

9. The hydraulic port weld stud of claim 8 wherein the male port includes threads on an outer surface of the generally cylindrical body and tapering down to a fitting end.

10. The hydraulic port weld stud of claim 7 wherein the female attachment port includes a generally cylindrical body having formations selected from the group consisting of threads, flares and shaped portions.

11. The hydraulic port weld stud of claim 10 wherein the female port includes threads on an inner surface of the generally cylindrical body, allowing for mating with a male coupling.

12. The hydraulic port weld stud of claim 1 wherein the first bore is extended through the stud portion following a joining operation attaching the stud portion to a part to be joined.

13. A hydraulic port weld stud comprising:
a stud portion having a longitudinal axis and a first bore formed along the longitudinal axis of the stud portion;
a port portion extending along an axis transverse to the longitudinal axis of the stud portion, the port portion including a second bore extending along the transverse axis and intersecting the first bore of the stud portion;
wherein the port portion and stud portion are formed from a single piece.

14. The hydraulic port weld stud of claim 13 wherein the first bore initially extends along the longitudinal axis a distance less than an entire length of the stud portion.

15. The hydraulic port weld stud of claim 14 wherein following an operation attaching the stud portion to a part to be joined, the first bore is extended through the stud portion.

16. The hydraulic port weld stud of claim 13 wherein The hydraulic port weld stud is hot formed.

17. The hydraulic port weld stud of claim 13 wherein the hydraulic port weld stud is cold formed.
